(19) United States
(12) Patent Application Publication
(10) Pub. No.: US 2025/0082030 A1
(43) Pub. Date: Mar. 13, 2025

(54) AEROSOL GENERATING DEVICE, AEROSOL GENERATING SYSTEM INCLUDING THE SAME, AND METHOD OF MANUFACTURING AEROSOL GENERATING DEVICE

(71) Applicant: KT&G CORPORATION, Daejeon (KR)

(72) Inventors: Young Bum KWON, Gyeonggi-do (KR); Dong Sung KIM, Seoul (KR); Yong Hwan KIM, Gyeonggi-do (KR); Hun II LIM, Seoul (KR)

(73) Assignee: KT&G CORPORATION, Daejeon (KR)

(21) Appl. No.: 18/569,537

(22) PCT Filed: Oct. 11, 2023
(86) PCT No.: PCT/KR2023/015629

§ 371 Date: Dec. 12, 2023

(30) Foreign Application Priority Data
Dec. 30, 2022 (KR) 10-2022-0191127
Mar. 8, 2023 (KR) 10-2023-0030812

(51) Int. Cl. A24F 40/465; A24D 1/20; A24F 40/20; A24F 40/485; A24F 40/51; A24F 40/65; A24F 40/70

(52) U.S. Cl. CPC A24F 40/465; A24D 1/20; A24F 40/20; A24F 40/485; A24F 40/51; A24F 40/70; A24F 40/65

(57) ABSTRACT

An aerosol generating device includes a cylindrical accommodation portion having an accommodation space configured to accommodate at least a portion of a cigarette in an inner space, a coil arranged outside the accommodation portion to generate an induced magnetic field, a battery configured to supply power to the coil, a sensor connector including a metal material, and arranged in the accommodation portion to contact the cigarette, a temperature sensor contacting the sensor connector, and two or more cigarette support elements supporting an outer surface of the cigarette, and spaced apart from each other on an inner wall of the accommodation portion to form an air flow passage between the cigarette and the accommodation portion.

### TECHNICAL FIELD

Embodiments relate to an aerosol generating device, an aerosol generating system including the same, and a method of manufacturing an aerosol generating device, and more particularly, to an aerosol generating device for accurately measuring a temperature of a cigarette, an aerosol generating system including the same, and a method of manufacturing an aerosol generating device.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

Recently, attempts to miniaturize aerosol generating devices have increased to enhance user portability and convenience. However, in miniaturized induction heating-type aerosol generating devices, since, for example, separate spaces for susceptors may not be provided, temperature sensors may not be easily arranged appropriately.

Therefore, a method of accurately measuring and controlling a temperature even in a miniaturized device needs to be provided.

### DISCLOSURE

### Technical Problem

Various embodiments provide an aerosol generating device, an aerosol generating system including the same, and a method of manufacturing an aerosol generating device. Embodiments provide an aerosol generating device capable of accurately measuring a temperature even in a miniaturized device, an aerosol generating system including the same, and a method of manufacturing an aerosol generating device.

The problems to be solved by embodiments are not limited to the problems described above, and problems not mentioned may be clearly understood by one of ordinary skill in the art to which the embodiments belong from the description and the accompanying drawings.

### Technical Solution

According to an aspect of the disclosure, an aerosol generating device includes a cylindrical accommodation portion having an accommodation space accommodating at least a portion of a cigarette in an inner space, a coil arranged outside the accommodation portion to generate an induced magnetic field, a battery configured to supply power to the coil, a sensor connector including a metal material, and arranged in the accommodation portion to contact the cigarette, a temperature sensor contacting the sensor connector, and two or more cigarette support elements supporting an outer surface of the cigarette, and spaced apart from each other on an inner wall of the accommodation portion to form an air flow passage between the cigarette and the accommodation portion.

According to another aspect of the disclosure, an aerosol generating system includes a cigarette including an aerosol generating material and a tobacco material, a cylindrical accommodation portion having an accommodation space accommodating at least a portion of the cigarette in an inner space, a coil arranged along an outer circumferential surface of the accommodation portion to generate an induced magnetic field, a susceptor configured to generate heat due to a magnetic field generated by the coil to heat the cigarette, a battery configured to supply power to the coil, a sensor connector including a metal material, and arranged in the accommodation portion to contact the cigarette, a temperature sensor contacting the sensor connector, and two or more cigarette support elements supporting an outer surface of the cigarette, and spaced apart from each other on an inner wall of the accommodation portion to form an air flow passage between the cigarette and the accommodation portion.

According to another aspect of the disclosure, a method of manufacturing an aerosol generating device includes integrally forming the sensor connector and the accommodation portion by using an insert molding method.

### Advantageous Effects

According to an aerosol generating device, an aerosol generating system including the same, and a method of manufacturing an aerosol generating device according to embodiments, a temperature of a cigarette may be accurately measured even in a miniaturized device.

Effects of the present disclosure are not limited to the above effects, and effects that are not mentioned could be clearly understood by one of ordinary skill in the art from the present specification and the attached drawings.

### DESCRIPTION OF DRAWINGS

FIG. 1 is diagram showing an example in which a cigarette is inserted into an aerosol generating device, in accordance with an embodiment.

FIG. 2 is a view schematically illustrating a cross section in a direction crossing a longitudinal direction of an accommodation portion of an aerosol generating device, according to an embodiment.

FIGS. 3A and 3B are views schematically illustrating a cross section in a longitudinal direction of an accommodation portion, according to embodiments.

FIGS. 4A and 4B are views schematically illustrating a cross section in a longitudinal direction of an accommodation portion, according to some embodiments.

FIG. 5 is a perspective view schematically illustrating a cross section in a longitudinal direction of an accommodation portion, according to an embodiment.

FIG. 6 is a view schematically illustrating an arrangement of a coil, according to an embodiment.

FIGS. 7A to 7C schematically illustrate an arrangement of a sensor connector, according to embodiments.

FIG. 8 schematically illustrates an arrangement of a sensor connector, according to an embodiment.

FIGS. 9A and 9B schematically illustrate a cross section in a longitudinal direction of an accommodation portion to describe an arrangement of a susceptor, according to embodiments.

FIGS. 10A and 10B schematically illustrate a cigarette according to embodiments.

FIG. 11 is a block diagram of an aerosol generating device according to an embodiment.

### MODE FOR INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

Hereinafter, the present disclosure will now be described more fully with reference to the accompanying drawings, in which exemplary embodiments of the present disclosure are shown such that one of ordinary skill in the art may easily work the present disclosure. But, the present disclosure may be implemented in a form that can be implemented in various different forms, and is not limited to the embodiments described herein.

As used herein, embodiments are arbitrary divisions for easily describing the disclosure, and the embodiments do not need to be exclusive to each other. For example, components disclosed in an embodiment may be applied and/or implemented in other embodiments, and may be changed and applied and/or implemented without departing from the scope of the disclosure.

In addition, the terms used herein are for describing embodiments and are not intended to limit the embodiments. As used herein, the singular forms are intended to include the plural forms as well, unless the context clearly indicates otherwise.

Some components in the drawings may be illustrated by exaggerating their sizes or ratios. In addition, components illustrated on one drawing may not be illustrated on another.

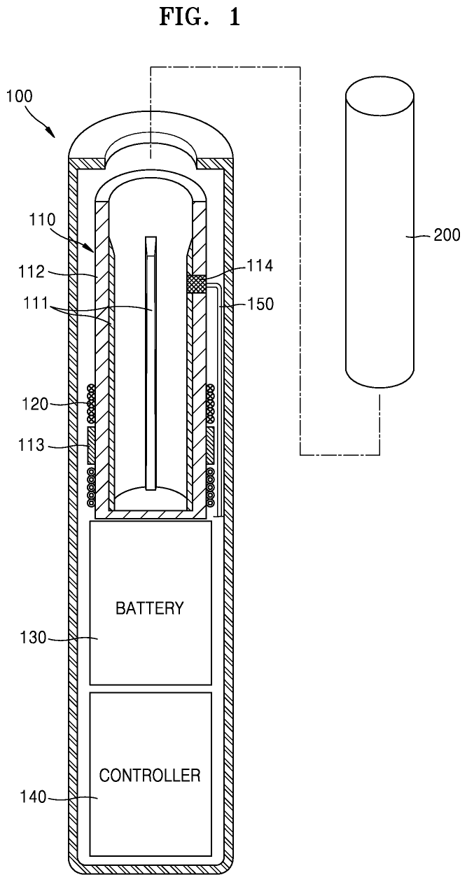

Also, as used herein, a longitudinal direction of a component may be a direction in which the component extends along one direction axis of the component. Here, the one direction axis of the component may refer to a direction in which the component extends longer than the other direction axis crossing the one direction axis. For example, as illustrated in FIG. 1, a longitudinal direction of an accommodation portion 110 may refer to a direction in which the accommodation portion 110 having a cylindrical shape extends, i.e., a height direction of a cylinder perpendicular to an axis forming a diameter of the cylinder.

Hereinafter, embodiments of the present disclosure will be described in detail with reference to the drawings.

FIG. 1 is a view schematically illustrating an example in which a cigarette is inserted into an aerosol generating device, according to an embodiment.

Referring to FIG. 1, an aerosol generating device 100 may include the accommodating portion 110, a coil 120, a battery 130, a controller 140, and a temperature sensor 150. In addition, other elements may be further included in addition to the elements illustrated in FIG. 1. The arrangement of the elements illustrated in FIG. 1 may be changed according to the design of the aerosol generating device 100.

The aerosol generating device 100 may generate an aerosol by heating a cigarette 200 in an induction heating method. The induction heating method may refer to a method of generating heat from a magnetic body by applying an alternating magnetic field.

When the alternating magnetic field is applied to the magnetic body, an energy loss due to an eddy current loss and a hysteresis loss may occur in the magnetic body. The energy that is lost may be emitted from the magnetic body as thermal energy. When an amplitude or frequency of the alternating magnetic field increases, a large amount of thermal energy may be emitted from the magnetic body.

The battery 130 may supply power used to operate the aerosol generating device 100. For example, the battery 130 may supply power so that an alternating current may be applied to the coil 120, and may supply power needed for the controller 140 to operate. In addition, the battery 130 may supply power needed for a display, a sensor, a motor, and the like installed in the aerosol generating device 100 to operate.

The controller 140 may control overall operation of the aerosol generating device 100. In detail, the controller 140 may control operations of the coil 120 and the battery 130, as well as operations of the other components included in the aerosol generating device 100. In addition, the controller 140 may determine whether or not the aerosol generating device 100 is in an operable state, by identifying a state of each of the components of the aerosol generating device 100.

The controller 140 may include at least one processor. The processor may be implemented as an array of a plurality of logical gates, or a combination of a general-purpose microprocessor and a memory that stores programs that may be executed by the microprocessor. In addition, it may be understood by one of ordinary skill in the art to which the present embodiment belongs that the processor may be implemented as other types of hardware.

The accommodation portion 110 may have a cylindrical shape having an accommodation space for accommodating at least a portion of the cigarette 200 in an inner space. The accommodation portion 110 may include an opening opened from the outside of the accommodation space to accommodate the cigarette 200 in the aerosol generating device 100. The opening may be opened toward the outside of the aerosol generating device 100. The cigarette 200 may be accommodated in the accommodation space in a direction from the outside of the accommodation portion 110 toward the inside of the accommodation portion 110 through the opening.

The accommodation portion 110 may be arranged between the cigarette 200 inserted into the accommodation space and the coil 120 to insulate heat of a susceptor heated by the coil 120 from moving to the outside. As a detailed example, the accommodation portion 110 may have a wall 112 formed of an insulating material.

The accommodation portion 110 may have a cylindrical shape so that the accommodation portion 110 may surround at least a portion of the cigarette 200 when the cigarette 200 is inserted into the accommodation space. For example, the accommodation portion 110 may have a cylindrical shape similar to an outer shape of the cigarette 200.

The coil 120 for generating an induced magnetic field may be arranged outside the accommodation portion 110. The coil 120 may be electrically connected to the battery 130 and the controller 140. The coil 120 may generate an aerosol by heating the cigarette 200 by using power supplied through the battery 130 and the controller 140.

The coil 120 may generate the induced magnetic field by receiving power from the battery 130. When the coil 120 generates a magnetic field, a susceptor (not shown) may generate heat by the magnetic field formed by the coil 120, and thus, the cigarette 200 may be heated. The susceptor may be included inside the cigarette 200 or inside the aerosol generating device 100, or may be included in both. A detailed description of the susceptor is given below.

When power is supplied to the coil 120, a magnetic field may be formed in the accommodation space of the accommodation portion 110. When an alternating current is applied to the coil 120, a direction of the magnetic field formed inside the accommodation space may be periodically changed. When an amplitude or frequency of the magnetic field formed by the coil 120 changes, a temperature of the susceptor heated may change.

The controller 140 may adjust an amplitude or frequency of an alternating magnetic field formed by the coil 120 by controlling power supplied to the coil 120, and accordingly, the temperature of the susceptor may be controlled.

As an example, the coil 120 may include copper, but is not limited thereto. The coil 120 may include any one of silver (Ag), gold (Au), aluminum (Al), tungsten (W), zinc (Zn), and nickel (Ni), or an alloy including at least one thereof, so that the coil 120 allows a high current to flow therethrough by having low specific resistance.

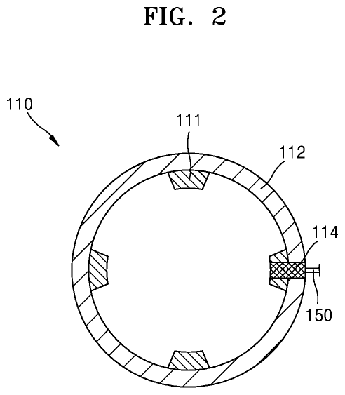

FIG. 2 is a view schematically illustrating a cross section in a direction crossing a longitudinal direction of an accommodation portion of an aerosol generating device, according to an embodiment.

According to an embodiment, an accommodation portion 110 may include two or more cigarette support elements 111. The cigarette support elements 111 may be arranged on an inner wall of the accommodation portion 110, and thus may support an outer surface of the cigarette 200 when the cigarette 200 is accommodated in an accommodation space of the accommodation portion 110. Referring to FIG. 2, the accommodation portion 110 of the aerosol generating device 100 may include four cigarette support elements 111.

In addition, the cigarette support elements 111 may allow an air flow passage to be formed between the cigarette 200 and the accommodation portion 110. In other words, two or more cigarette support elements 111 may be arranged on the inner wall of the accommodation portion 110, and the respective cigarette support elements 111 may be spaced apart from each other to form the air flow passage. The cigarette support elements 111 may be formed of the same material as the accommodation portion 110, and may be formed integrally with the accommodation portion 110 in a form extending from the inner wall of the accommodation portion 110.

FIG. 2 illustrates that four cigarette support elements 111 are spaced apart from one another at the same distance. However, when the cigarette support elements 111 is arranged to appropriately support the cigarette 200, the respective cigarette support elements 111 do not need to be spaced apart from one another at the same distance.

In addition, the shapes and number of cigarette support elements 111 are not limited when capable of forming an appropriate air flow passage while supporting the cigarette 200. For example, two to eight cigarette support elements 111 may be provided.

The accommodation portion 110 according to an embodiment may include a sensor connector 114 formed of a metal material, which is in contact with the cigarette 200 when the cigarette 200 is inserted into the aerosol generating device 100.

The sensor connector 114 may be included in a portion of the cigarette support element 111 of the accommodation portion 110. In other words, a portion of the cigarette support element 111 may include a metal material, and the portion including the metal material may be referred to as the sensor connector 114. In addition, the sensor connector 114 may be included in portions of the cigarette support element 111 of the accommodation portion 110 and a wall 112 of the accommodation portion 110. In other words, as illustrated in FIG. 2, the sensor connector 114 may be formed of metal in portions of the cigarette support element 111 and the wall 112 of the accommodation portion 110.

FIG. 2 illustrates that a cross section of the sensor connector 114 has a rectangular shape. However, an area or shape of the sensor connector 114 is not limited when the sensor connector 114 is capable of transferring heat of the cigarette 200 by contacting the cigarette 200.

In addition, the metal material included in the sensor connector 114 may include a metal material capable of transferring heat, such as aluminum, copper, nickel, iron, chromium, or an alloy thereof, but is not limited thereto.

A temperature sensor 150 may be in contact with the sensor connector 114. The temperature sensor 150 may measure a temperature, which is similar to a temperature of the cigarette 200, by contacting the sensor connector 114 including the metal material, which is in contact with the cigarette 200. The contact form between the temperature sensor 150 and the sensor connector 114 is not limited. For example, the temperature sensor 150 may be in physical contact with the sensor connector 114 through a separate coupling element or the like, or may be welded to the sensor connector 114.

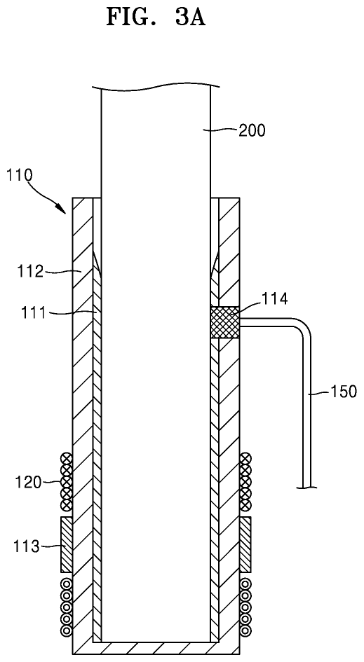

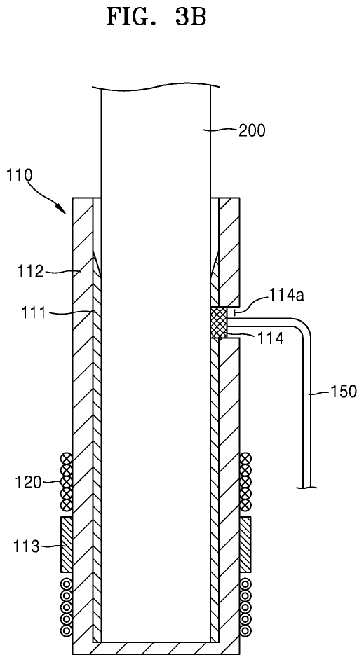

FIGS. 3A and 3B are views schematically illustrating a cross section in a longitudinal direction of an accommodation portion, according to embodiments.

FIG. 3A illustrates a connection form between a sensor connector 114 and a temperature sensor 150, according to an embodiment.

Referring to FIG. 3A, the sensor connector 114 may be included in a portion of an accommodation portion 110. The sensor connector 114 may be in contact with a cigarette 200, and at the same time may be in contact with the temperature sensor 150. The sensor connector 114 may be arranged across a cigarette support element 111 and the accommodation portion 110 to contact the cigarette 200 and the temperature sensor 150.

In detail, the sensor connector 114 may refer to an entire portion formed of metal in a portion of the cigarette support element 111 and a portion of a wall 112 of the accommodation portion 110 in contact with the cigarette support element 111.

On the basis of a cross section of the accommodation portion 110 shown in FIG. 3A in a longitudinal direction, a thickness of the sensor connector 114 shown in FIG. 3A may be equal to the sum of a thickness of the cigarette support element 111 and a thickness of the wall 112 of the accommodation portion 110. In other words, as illustrated in FIG. 3, the portion of the sensor connector 114 formed of metal may be exposed to an outer wall of the accommodation portion 110.

As illustrated in FIG. 3A, when the sensor connector 114 is exposed to the outer wall of the accommodation portion 110, the temperature sensor 150 may be easily welded to the sensor connector 114.

The sensor connector 114 may be arranged at a location that is little affected by a magnetic field generated by a coil 120. In other words, the sensor connector 114 may be spaced apart from the coil 120 not to be in contact with a coil 120.

The sensor connector 114 may be integrally formed with the accommodation portion 110. For example, the sensor connector 114 may be integrally formed with the accommodation portion 110 through insert molding. In other words, the sensor connector 114 may be integrally formed with the accommodation portion 110 by insert molding the sensor connector 114 including a metal material and the accommodation portion 110 having a portion which contacts the sensor connector 114 and includes a non-metal material.

The temperature sensor 150 may contact the sensor connector 114. In detail, one end of the temperature sensor 150 may contact the sensor connector 114, and the other end of the temperature sensor 150 may be connected to the controller 140 or the like outside the accommodation portion 110. Contact may refer to electrically connected.

The temperature sensor 150 may use a thermocouple, a resistance temperature detector (RTD), or a thermistor, but is not limited thereto.

From among the thermocouple, the RTD, and the thermistor, the thermocouple may include two different types of metal wires, and may be welded to the sensor connector 114 even without a separate welding rod. Two strands of metal wires of the thermocouple may be welded or twisted together, and thus may be welded to one sensor connector 114. Therefore, when the thermocouple is used, the connection structure of the temperature sensor 150 may be simplified. When the RTD or the thermistor is used as the temperature sensor 150, two sensor connectors 114, which are spaced apart from each other, may be needed.

FIG. 3B illustrates a connection form between a sensor connector 114 and a temperature sensor 150, according to an embodiment.

Referring to FIG. 3B, the sensor connector 114 may be included in a portion of an accommodation portion 110. The sensor connector 114 may be in contact with a cigarette 200, and at the same time may be in contact with the temperature sensor 150. The sensor connector 114 may be arranged across a cigarette support element 111 and the accommodation portion 110 to contact the cigarette 200 and the temperature sensor 150.

On the basis of a cross section of the accommodation portion 110 shown in FIG. 3B in a longitudinal direction, a thickness of the sensor connector 114 shown in FIG. 3B may be smaller than the sum of a thickness of the cigarette support element 111 and a thickness of a wall 112 of the accommodation portion 110. In other words, the thickness of the sensor connector 114 may be equal to the sum of the thickness of the cigarette support member 111 and a portion of the thickness of the wall 112 of the accommodation portion 110.

As illustrated in FIG. 3B, although the sensor connector 114 is not formed of metal over the entire thickness of the wall 112 of the accommodation portion 110, a metal portion thereof may be observed from the outside of the accommodation portion 110 through a connection hole 114a. In other words, the connection hole 114a may be formed at a location corresponding to the sensor connector 114.

The temperature sensor 150 may contact the sensor connector 114. In detail, one end of the temperature sensor 150 may contact the sensor connector 114, and the other end of the temperature sensor 150 may be connected to the controller 140 or the like outside the accommodation portion 110. Contact may refer to electrically connected.

As illustrated in FIG. 3B, the sensor connector 114 may be observed from the outer wall of the accommodation portion 110 through the connection hole 114a, and thus, the temperature sensor 150 may contact the sensor connector 114 through the connection hole 114a.

In detail, referring to FIG. 3B, the temperature sensor 150 may be welded to the sensor connector 114 through the connection hole 114a. In other words, one end of the temperature sensor 150 may pass through the connection hole 114a and be welded to the sensor connector 114.

Similarly, the sensor connector 114 may be arranged at a location that is little affected by a magnetic field generated by a coil 120. In other words, the sensor connector 114 may be spaced apart from the coil 120 not to be in contact with the coil 120. In addition, even in the embodiment illustrated in FIG. 3B, the sensor connector 114 may be integrally formed with the accommodation portion 110 through insert molding.

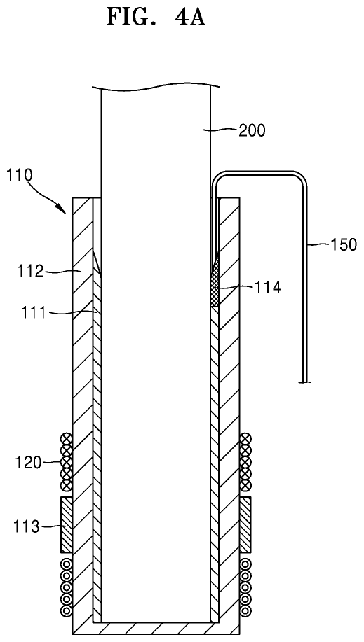

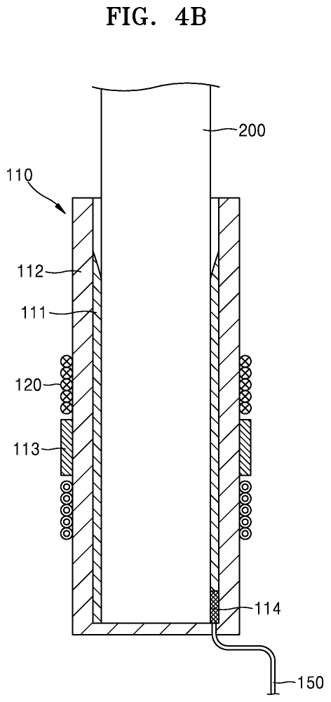

FIGS. 4A and 4B are views schematically illustrating a cross section of an accommodation portion in a longitudinal direction, according to some embodiments.

Even in the embodiments illustrated in FIGS. 4A and 4B, a sensor connector 114 may be arranged at a location that is little affected by a magnetic field generated by a coil 120. In other words, the sensor connector 114 may be spaced apart from the coil 120 not to be in contact with the coil 120. In addition, even in the embodiment illustrated in FIG. 4A, the sensor connector 114 may be integrally formed with an accommodation portion 110 through insert molding.

FIG. 4A illustrates a connection form between the sensor connector 114 and a temperature sensor 150, according to an embodiment.

Referring to FIG. 4A, the sensor connector 114 may be included in a portion of the accommodation portion 110. The sensor connector 114 may be in contact with a cigarette 200, and at the same time may be in contact with the temperature sensor 150. The sensor connector 114 may be arranged only in a cigarette support element 111 to contact the cigarette 200 and the temperature sensor 150. In detail, the sensor connector 114 may be included in an upper end portion of the cigarette support element 111 in a longitudinal direction.

On the basis of a cross section of the accommodation portion 110 shown in FIG. 4A in the longitudinal direction, a thickness of the sensor connector 114 shown in FIG. 4A may be equal to or less than a thickness of the cigarette support element 111. In other words, as illustrated in FIG. 4A, a portion of the sensor connector 114, which is formed of metal, may be arranged only in the portion of the cigarette support element 111 and may not be observed from the outside of the accommodation portion 110.

However, when the sensor connector 114 contacts the cigarette 200, the thickness thereof may be greater than the thickness of the cigarette support element 111. When the sensor connector 114 is in contact with the cigarette 200 and the thickness thereof is greater than the thickness of the cigarette support element 111, the sensor connector 114 may be included even in a portion of a wall 112 of the accommodation portion 110.

The temperature sensor 150 may contact the sensor connector 114. In detail, one end of the temperature sensor 150 may contact the sensor connector 114 inside the accommodation portion 110, and the other end of the temperature sensor 150 may be located outside the accommodation portion 110. In other words, in the embodiments illustrated in FIGS. 3A and 3B, the sensor connector 114 and the temperature sensor 150 may be in contact with each other outside the accommodation portion 110. In contrast, in the embodiment illustrated in FIG. 4A, the sensor connector 114 and the temperature sensor 150 may be in contact with each other inside the accommodation portion 110. The inside of the accommodation portion 110 may refer to an inner wall portion of the accommodation portion 110.

FIG. 4B illustrates a connection form between a sensor connector 114 and a temperature sensor 150, according to an embodiment.

Referring to FIG. 4B, the sensor connector 114 may be arranged only in a cigarette support element 111 to contact a cigarette 200 and the temperature sensor 150. In detail, the sensor connector 114 may be included in a lower end portion of the cigarette support element 111 in a longitudinal direction.

On the basis of a cross section of an accommodation portion 110 shown in FIG. 4B in the longitudinal direction, a thickness of the sensor connector 114 shown in FIG. 4B may be equal to or less than a thickness of the cigarette support element 111. In other words, as illustrated in FIG. 4B, a portion of the sensor connector 114, which is formed of metal, may be arranged only in the portion of the cigarette support element 111, and thus may not be observed outside the accommodation portion 110.

However, when the sensor connector 114 contacts the cigarette 200, the thickness thereof may also be greater than the thickness of the cigarette support element 111. When the sensor connector 114 is in contact with the cigarette 200 and the thickness thereof is greater than the thickness of the cigarette support element 111, the sensor connector 114 may be included even in a portion of a wall 112 of the accommodation portion 110.

Similarly, the temperature sensor 150 may be in contact with the sensor connector 114. In detail, one end of the temperature sensor 150 may contact the sensor connector 114 inside the accommodation portion 110, and the other end of the temperature sensor 150 may be located outside the accommodation portion 110. The inside of the accommodation portion 110 may refer to an inner wall portion of the accommodation portion 110.

As shown in FIG. 4B, when the sensor connector 114 is arranged in the lower end portion of the cigarette support element 111, the other end of the temperature sensor 150 may be located outside the accommodation portion 110 through a separate hole. As illustrated in FIG. 4B, the other end of the temperature sensor 150 may be withdrawn through a lower end of the accommodation portion 110, but may also be withdrawn through the wall 112 of the accommodation portion 110.

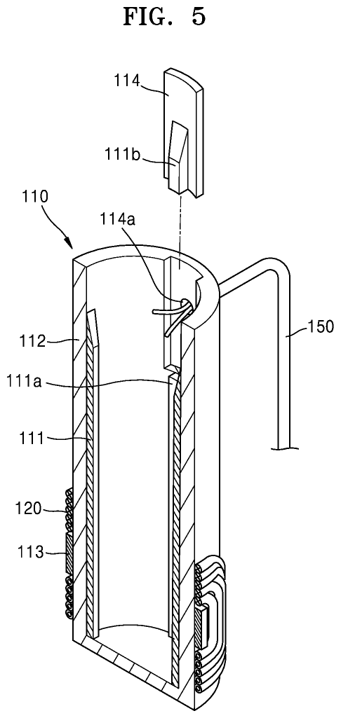

FIG. 5 is a perspective view schematically illustrating a cross section of an accommodation portion in a longitudinal direction, according to an embodiment.

Unlike the embodiments of FIGS. 3A to 4B in which the sensor connector 114 and the accommodation portion 110 are integrally formed, according to the embodiment illustrated in FIG. 5, a sensor connector 114 and an accommodation portion 110 may be formed separately.

Referring to FIG. 5, the accommodation portion 110 may include an accommodation groove, and the sensor connector 114 may include a base coupled to the accommodation groove, and a protrusion 111b protruding from the base to connect with a cigarette support element 111 of the accommodation portion 110.

The sensor connector 114 may have a structure coupled to the accommodation groove formed in the accommodation portion 110 to fix the temperature sensor 150. Here, the sensor connector 114 and the temperature sensor 150 do not need separate welding, and may be fixed when the sensor connector 114 is coupled to the accommodation portion 110.

For example, one end of the temperature sensor 150 may be located inside the accommodation portion 110 through a connection hole 114a formed in the accommodation portion 110. When the sensor connector 114 is coupled into the accommodation groove of the accommodation portion 110 in a longitudinal direction of the accommodation portion 110, the one end of the temperature sensor 150 located inside the accommodation portion 110 may be inserted between the accommodation portion 110 and the temperature sensor 150.

The sensor connector 114 may include the base and the protrusion 111b. The base of the sensor connector 114 may be coupled into the accommodation groove of the accommodation portion 110. In addition, the protrusion 111b protruding from the base of the sensor connector 114 may be connected to a cigarette support element 111a of the accommodation portion 110 when the sensor connector 114 is inserted into the accommodation groove of the accommodation portion 110. When the cigarette 200 is inserted into an inner space of the accommodation portion 110, the protrusion 111b of the sensor connector 114 may contact an outer surface of the cigarette 200.

FIG. 5 illustrates that a portion of a wall 112 of the accommodation portion 110 has a form corresponding to the base of the sensor connector 114. However, when the wall 112 of the accommodation portion 110 has any structure that may fix the temperature sensor 150 by coupling the sensor connector 114 to the accommodation portion 110, the form thereof is not limited.

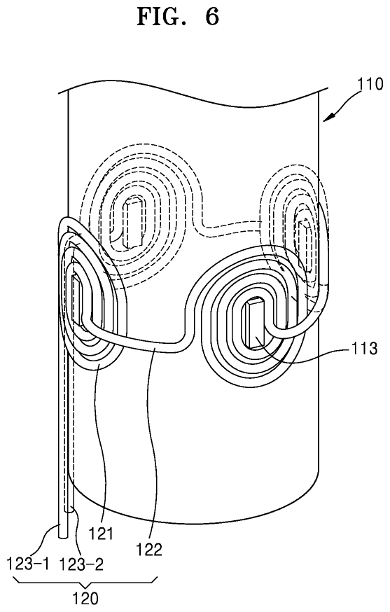

FIG. 6 is a view schematically illustrating an arrangement of a coil, according to an embodiment.

A coil 120 capable of generating a magnetic field by receiving power may be arranged on an outer circumferential surface of an accommodation portion 110. The coil 120 may be arranged to surround a portion of the outer circumferential surface of the accommodation portion 110.

The coil 120 may be implemented in a solenoid shape formed by being wound long in a longitudinal direction of a virtual cylinder. A virtual cylindrical space may be formed in an inner portion surrounded by a solenoid-shaped coil. An accommodation space into which the cigarette 200 is inserted may be formed in an inner space surrounded by the coil 120. In addition, the accommodation portion 110 including the accommodation space may be arranged. When a current flows through the coil 120 having the solenoid shape, a magnetic field, which passes through the inner space surrounded by the coil 120, may be formed. The magnetic field may pass through the cigarette 200 accommodated inside the accommodation portion 110.

As shown in FIG. 6, the coil 120 may also be wound around a central axis extending in a direction crossing the longitudinal direction of the accommodation portion 110. The coil 120 may be wound in a shape in which a diameter thereof gradually increases with a central axis at one point of an outer surface of the accommodation portion 110. Referring to FIG. 6, the coil 120 may form a curved surface, and the curved surface may be arranged to surround a portion of the outer circumferential surface of the accommodation portion 110.

When the coil 120 is arranged as shown in FIG. 6, the magnetic field formed by the coil 120 may pass through the inner space of the accommodation portion 110 in the direction crossing the longitudinal direction of the accommodation portion 110. In the above arrangement, the temperature sensor 150 may be connected to a location closer to the cigarette 200.

FIG. 6 illustrates an example of a form in which the coil 120 is wound around the outer circumferential surface of the accommodation portion 110 with a plurality of central axes spaced apart from each other. Referring to FIG. 6, the coil 120 may include a single conductive wire, and may have four spiral coils 121 that are wound around four central axes. FIG. 6 is an example, and the number, size, and shape of the spiral coils 121 may be modified as needed. For example, FIG. 6 illustrates that the spiral coils 121 are wound in a circular shape, but the spiral coils 121 may have a shape wound in a square shape.

The respective spiral coils 121 may have the same size and shape and may be connected to one another through a coil connector 122. The coil 120 may include the single conductive wire, and thus may have a pair of power supply lines 123-1 and 123-2 at both ends thereof.

Referring to the embodiment of FIG. 6, the four spiral coils 121 may form two pairs and be symmetrically arranged around the accommodation portion 110. In the above arrangement, the respective pairs of spiral coils 121 may be arranged so that the spiral coils 121 are wound around the same central axis and currents flow through the spiral coils 121 in the same direction (a clockwise or counterclockwise direction). Through the above arrangement, a ratio at which the magnetic field is offset may be minimized.

According to an embodiment, the accommodation portion 110 may further include a coil support portion 113 in a region of the outer circumferential surface thereof. The coil 120 may be wound around the coil support portion 113 as a central axis to form the spiral coil 121. As illustrated in FIG. 6, the coil support portion 113 may protrude from the outer circumferential surface of the accommodation portion 110, but is not limited thereto. The coil support portion 113 may operate as a central axis around which the coil 120 is wound and may support the coil 120. However, although the coil support portion 113 does not support the coil 120, the coil support portion 113 may operate to display a location of a central axis around which the coil 120 is wound.

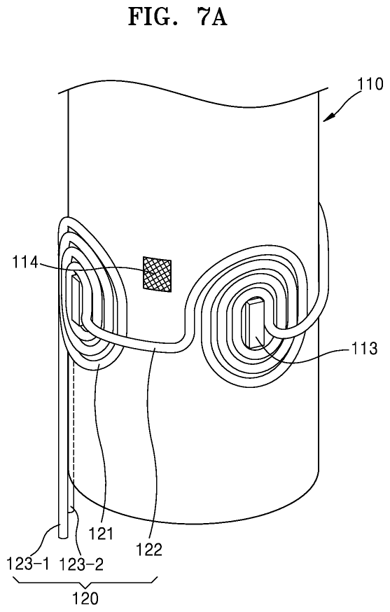

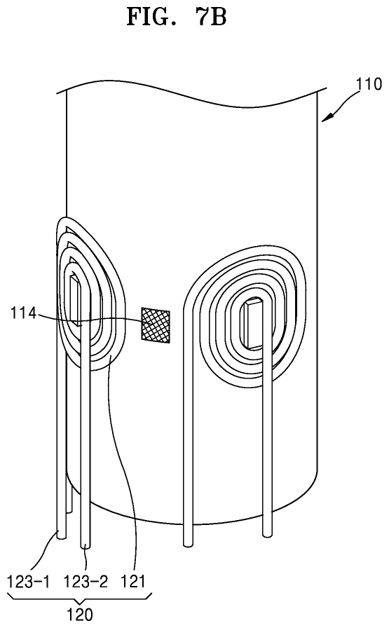

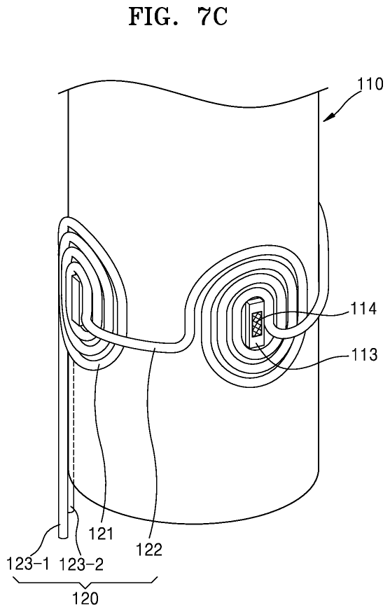

FIGS. 7A to 7C schematically illustrate an arrangement of a sensor connector, according to embodiments.

Referring to FIGS. 7A to 7C, a sensor connector 114 may be formed at a location at which a coil 120 is not wound. In other words, the temperature sensor 150 may be connected to the location at which the coil 120 is not wound. Accordingly, the sensor connector 114 may be arranged at a location that is close to a cigarette while avoiding a location directly affected by a magnetic field generated by the coil 120.

Referring to FIG. 7A, the sensor connector 114 may be spaced apart from the coil 120, between a plurality of central axes spaced apart from each other. In other words, the sensor connector 114 may be located between spiral coils 121.

FIG. 7A illustrates an example of a form in which the coil 120 is wound around a plurality of central axes spaced apart from each other with a single conductive wire, as shown in FIG. 6. The coil 120 may include the single conductive wire, and thus, the respective spiral coils 121 may have a coil connector 122. Here, the sensor connector 114 may be spaced apart from the coil connector 122 to be spaced apart from the coil 120.

As illustrated in FIG. 7A, when the sensor connector 114 is spaced apart from the coil 120 and the coil connector 122, the sensor connector 114 may be arranged at the location that is close to the cigarette while avoiding the location directly affected by the magnetic field generated by the coil 120, and thus, a temperature of the cigarette may be relatively accurately sensed.

In the embodiment of FIG. 7A, the sensor connector 114 may be located between two spiral coils 121 and above the coil connector 122 connecting the two spiral coils 121 (at an upper end in a longitudinal direction of an accommodation portion 110), but is not limited thereto.

FIG. 7B illustrates an example of a form in which a coil 120 is wound with a plurality of conductive wires. In other words, the coil 120 may be wound with different conductive wires around a plurality of central axes, respectively, which are spaced apart from each other. Here, the coil connector 122 may not be needed, and the sensor connector 114 may be arranged at a location of the coil connector 122.

Referring to FIG. 7B, the sensor connector 114 may be located between the spiral coils 121 and between central axes of the spiral coils 121. A location at which the sensor connector 114 is arranged may be at the same distance or different distances from the respective central axes of the respective spiral coils 121. However, when the sensor connector 114 is arranged at the location that is at the same distance from the respective central axes of the respective spiral coils 121, an influence of a magnetic field may be minimized.

As illustrated in FIG. 7B, when the sensor connector 114 is spaced apart from the coil 120 and the spiral coils 121, the sensor connector 114 may be arranged at the location that is close to the cigarette while avoiding the location directly affected by the magnetic field generated by the coil 120, and thus, a temperature of the cigarette may be relatively accurately sensed.

FIG. 7C illustrates a form in which a sensor connector 114 is arranged in a coil support portion 113. The sensor connector 114 may be arranged so that a metal portion thereof may be observed from the outside of the coil support portion 113. In detail, when the coil support portion 113 protrudes, a portion of the coil support portion 113, which protrudes, may also be formed of metal, and the temperature sensor 150 may be in contact with the portion.

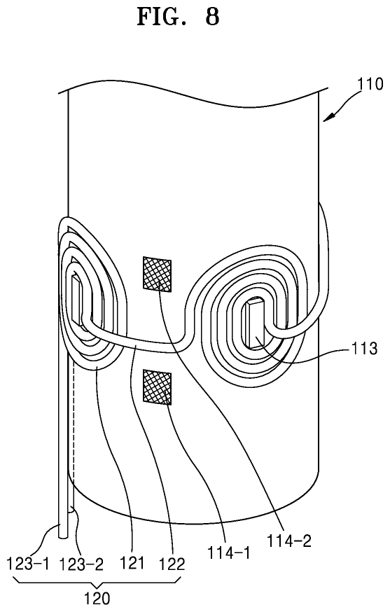

FIG. 8 schematically illustrates an arrangement of a sensor connector, according to an embodiment.

Two or more sensor connectors 114 may be arranged. The temperature sensors 150 may be respectively connected to the two or more sensor connectors 114. Referring to FIG. 8, the temperature sensors 150 may measure temperatures of respective segments of the cigarette 200, and the controller 140 may precisely control the respective temperatures. The description thereof is given below together with the description of the cigarette 200.

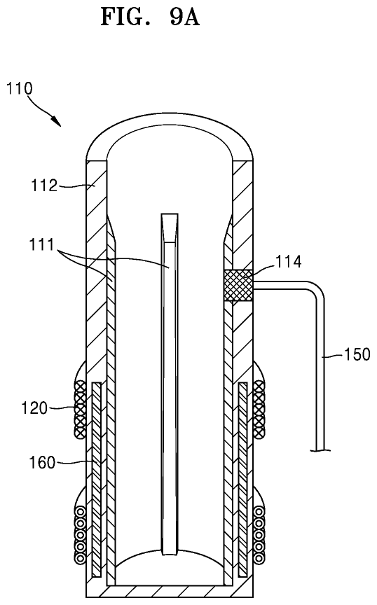

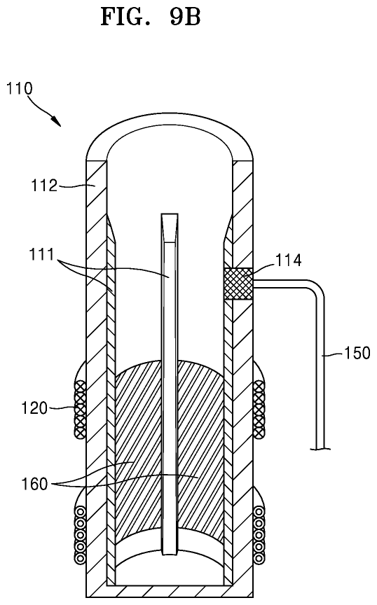

FIGS. 9A and 9B schematically illustrate a cross section of an accommodation portion in a longitudinal direction to describe an arrangement of a susceptor, according to embodiments.

According to an embodiment, a susceptor may be included inside the cigarette 200 or inside the aerosol generating device 100, or may be included in both. However, FIGS. 9A and 9B illustrate that the susceptor is included in the aerosol generating device 100.

According to FIGS. 9A and 9B, the aerosol generating device 100 may include a susceptor 160 that generates heat due to a magnetic field generated by a coil 120, is arranged to surround at least a portion of the cigarette 200 inserted into an accommodation portion 110, and heats the cigarette 200.

The susceptor 160 may be insert molded into the accommodation portion 110 or arranged adjacent to an inner circumferential surface of the accommodation portion 110. In addition, the susceptor 160 may be spaced apart from a sensor connector 114.

Referring to FIG. 9A, the susceptor 160 may be insert molded into the accommodation portion 110 and formed in a form embedded in a wall 112 of the accommodation portion 110. The susceptor 160 may be formed to have a cylindrical shape to heat the cigarette 200 accommodated in the accommodation portion 110, but is not limited thereto.

Referring to FIG. 9B, a susceptor 160 may be arranged adjacent to an inner circumferential surface of an accommodation portion 110. Even in this case, the susceptor 160 may be insert molded, but may also be adhered onto the inner circumferential surface of the accommodation portion 110.

In the embodiment illustrated in FIG. 9B, the susceptor 160 may be arranged on the inner circumferential surface of the accommodating portion 110 between distances at which cigarette support elements 111 are spaced apart from one another. In other words, one or more susceptors 160 may be arranged on the inner circumferential surface of the accommodation portion 110 between respective cigarette support elements 111.

Meanwhile, an embodiment relates to an aerosol generating system including the cigarette 200 together with the aerosol generating device 100 as described above.

An aerosol generating system according to an embodiment may include: the cigarette 200 including an aerosol generating material and a tobacco material; the accommodation portion 110 having a cylindrical shape and having an accommodation space accommodating at least a portion of the cigarette 200 in an inner space; the coil 120 arranged along an outer circumferential surface of the accommodation portion 110 to generate an induced magnetic field; the susceptor 160 configured to generate heat due to a magnetic field generated by the coil 120 and to heat the cigarette 200; the battery 130 configured to supply power to the coil 120; the sensor connector 114 including a metal material and arranged in the accommodation portion 110 to contact the cigarette 200; the temperature sensor 150 contacting the sensor connector 114; and two or more cigarette support elements configured to support an outer surface of the cigarette 200 and spaced apart from each other on an inner wall of the accommodation portion 110 to form an air flow passage between the cigarette 200 and the accommodation portion 110.

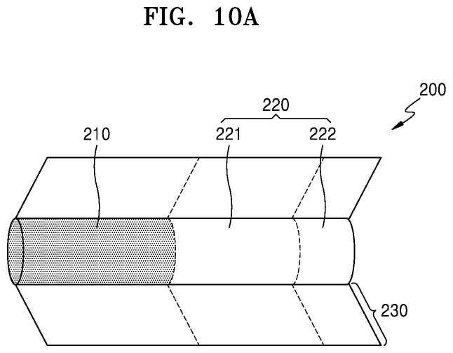

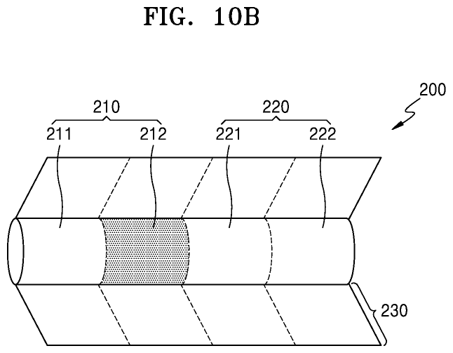

FIGS. 10A and 10B schematically illustrate a cigarette according to embodiments.

Referring to FIGS. 10A and 10B, a cigarette 200 according to an embodiment may include a tobacco rod 210 and a filter rod 220. The cigarette 200 may also include a wrapper 230 surrounding the tobacco rod 210 and the filter rod 220. The wrapper 230 may further include separate wrappers surrounding respective segments, and may finally include an external wrapper surrounding the entire cigarette 200.

In addition, the cigarette 200 may include the susceptor 160 therein. The susceptor 160 may be included in the tobacco rod 210, or may be included in a wrapper surrounding at least a portion of the tobacco rod 210.

When the susceptor 160 is included in the tobacco rod 210, the susceptor 160 may be formed in the form of a sheet or strand, and may be dispersed and arranged within the tobacco rod 210 in the form of fine particles.

The filter rod 220 may include a cellulose acetate filter. The filter rod 220 may include at least one segment. For example, the filter rod 220 may include a first segment 221 for cooling an aerosol and a second segment 222 for filtering a certain ingredient included in the aerosol.

The tobacco rod 210 may include an aerosol generating material and a tobacco material. As illustrated in FIG. 10A, the tobacco rod 210 may include one segment and may include both an aerosol generating material and a tobacco material.

Alternatively, the tobacco rod 210 may have two or more segments. For example, referring to FIG. 10B, a tobacco rod 210 may include a first segment 211 including an aerosol generating material and a second segment 212 including a tobacco material.

When the cigarette 200 has a structure as shown in FIG. 10B, the aerosol generating material and the tobacco material need to be controlled at different temperatures. In this case, two sensor connectors 114 arranged as shown in FIG. 8 may measure temperatures of the first segment 211 and the second segment 212, respectively.

In other words, when the cigarette 200 is inserted into the accommodation portion 110, the sensor connector 114 may include a first sensor connector 114-1 arranged at a location corresponding to the first segment 211 and a second sensor connector 114-2 arranged at a location corresponding to the second segment 212.

Accordingly, a first temperature sensor (not shown) for measuring a temperature of the first segment 211 by contacting the first sensor connector 114-1, and a second temperature sensor (not shown) for measuring a temperature of the second segment 212 by contacting the second sensor connector 114-2 may be included.

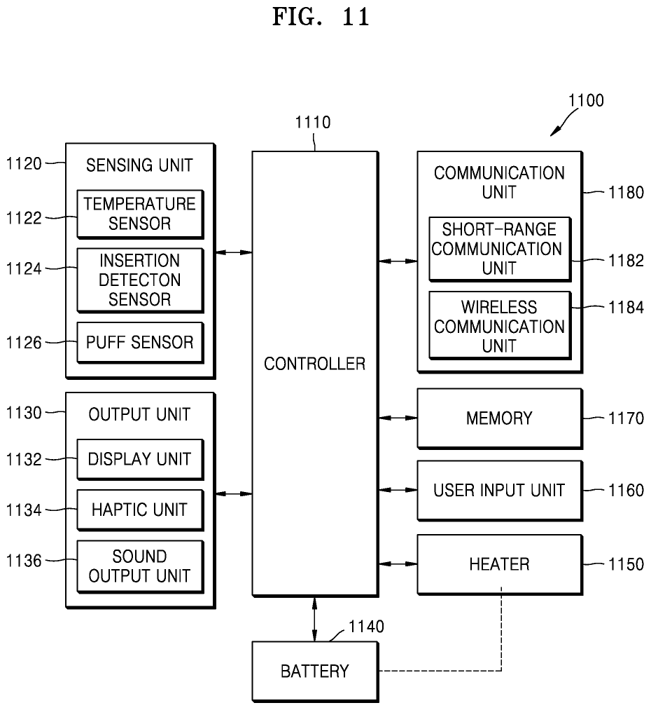

FIG. 11 is a block diagram of an aerosol generating device 1100 according to another embodiment.

The aerosol generating device 1100 may include a controller 1110, a sensing unit 1120, an output unit 1130, a battery 1140, a heater 1150, a user input unit 1160, a memory 1170, and a communication unit 1180. However, the internal structure of the aerosol generating device 1100 is not limited to those illustrated in FIG. 11. That is, according to the design of the aerosol generating device 1100, it will be understood by one of ordinary skill in the art that some of the components shown in FIG. 11 may be omitted or new components may be added.

The sensing unit 1120 may sense a state of the aerosol generating device 1100 and a state around the aerosol generating device 1100, and transmit sensed information to the controller 1110. Based on the sensed information, the controller 1110 may control the aerosol generating device 1100 to perform various functions, such as controlling an operation of the heater 1150, limiting smoking, determining whether an aerosol generating article (e.g., a cigarette, a cartridge, or the like) is inserted, displaying a notification, or the like.

The sensing unit 1120 may include at least one of a temperature sensor 1122, an insertion detection sensor 1124, and a puff sensor 1126, but is not limited thereto.

The temperature sensor 1122 may sense a temperature at which the heater 1150 (or an aerosol generating material) is heated. The aerosol generating device 1100 may include a separate temperature sensor for sensing the temperature of the heater 1150, or the heater 1150 may serve as a temperature sensor. Alternatively, the temperature sensor 1122 may also be arranged around the battery 1140 to monitor the temperature of the battery 1140.

The insertion detection sensor 1124 may sense insertion and/or removal of an aerosol generating article. For example, the insertion detection sensor 1124 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1126 may sense a user's puff on the basis of various physical changes in an airflow passage or an airflow channel. For example, the puff sensor 1126 may sense a user's puff on the basis of any one of a temperature change, a flow change, a voltage change, and a pressure change.

The sensing unit 1120 may include, in addition to the temperature sensor 1122, the insertion detection sensor 1124, and the puff sensor 1126 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1130 may output information on a state of the aerosol generating device 1100 and provide the information to a user. The output unit 1130 may include at least one of a display unit 1132, a haptic unit 1134, and a sound output unit 1136, but is not limited thereto. When the display unit 1132 and a touch pad form a layered structure to form a touch screen, the display unit 1132 may also be used as an input device in addition to an output device.

The display unit 1132 may visually provide information about the aerosol generating device 1100 to the user. For example, information about the aerosol generating device 1100 may mean various pieces of information, such as a charging/discharging state of the battery 1140 of the aerosol generating device 1100, a preheating state of the heater 1150, an insertion/removal state of an aerosol generating article, or a state in which the use of the aerosol generating device 1100 is restricted (e.g., sensing of an abnormal object), or the like, and the display unit 1132 may output the information to the outside. The display unit 1132 may be, for example, a liquid crystal display panel (LCD), an organic light-emitting diode (OLED) display panel, or the like. In addition, the display unit 1132 may be in the form of a light-emitting diode (LED) light-emitting device.

The haptic unit 1134 may tactilely provide information about the aerosol generating device 1100 to the user by converting an electrical signal into a mechanical stimulus or an electrical stimulus. For example, the haptic unit 1134 may include a motor, a piezoelectric element, or an electrical stimulation device.

The sound output unit 1136 may audibly provide information about the aerosol generating device 1100 to the user. For example, the sound output unit 1136 may convert an electrical signal into a sound signal and output the same to the outside.

The battery 1140 may supply power used to operate the aerosol generating device 1100. The battery 1140 may supply power such that the heater 1150 may be heated. In addition, the battery 1140 may supply power required for operations of other components (e.g., the sensing unit 1120, the output unit 1130, the user input unit 1160, the memory 1170, and the communication unit 1180) in the aerosol generating device 1100. The battery 1140 may be a rechargeable battery or a disposable battery. For example, the battery 1140 may be a lithium polymer (LiPoly) battery, but is not limited thereto.

The heater 1150 may receive power from the battery 1140 to heat an aerosol generating material. Although not illustrated in FIG. 11, the aerosol generating device 1100 may further include a power conversion circuit (e.g., a direct current (DC)/DC converter) that converts power of the battery 1140 and supplies the same to the heater 1150. In addition, when the aerosol generating device 1100 generates aerosols in an induction heating method, the aerosol generating device 1100 may further include a DC/alternating current (AC) that converts DC power of the battery 1140 into AC power.

The controller 1110, the sensing unit 1120, the output unit 1130, the user input unit 1160, the memory 1170, and the communication unit 1180 may each receive power from the battery 1140 to perform a function. Although not illustrated in FIG. 11, the aerosol generating device 1100 may further include a power conversion circuit that converts power of the battery 1140 to supply the power to respective components, for example, a low dropout (LDO) circuit, or a voltage regulator circuit.

In an embodiment, the heater 1150 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1150 may be implemented by a metal wire, a metal plate on which an electrically conductive track is arranged, a ceramic heating element, or the like, but is not limited thereto.

In another embodiment, the heater 1150 may be a heater of an induction heating type. For example, the heater 1150 may include a susceptor that heats an aerosol generating material by generating heat through a magnetic field applied by a coil.

The user input unit 1160 may receive information input from the user or may output information to the user. For example, the user input unit 1160 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 11, the aerosol generating device 1100 may further include a connection interface, such as a universal serial bus (USB) interface, and may connect to other external devices through the connection interface, such as the USB interface, to transmit and receive information, or to charge the battery 1140.

The memory 1170 is a hardware component that stores various types of data processed in the aerosol generating device 1100, and may store data processed and data to be processed by the controller 1110. The memory 1170 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1170 may store an operation time of the aerosol generating device 1100, the maximum number of puffs, the current number of puffs, at least one temperature profile, data on a user's smoking pattern, etc.

The communication unit 1180 may include at least one component for communication with another electronic device. For example, the communication unit 1180 may include a short-range wireless communication unit 1182 and a wireless communication unit 1184.

The short-range wireless communication unit 1182 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1184 may include a cellular network communication unit, an Internet communication unit, a computer network (e.g., local area network (LAN) or wide area network (WAN)) communication unit, or the like, but is not limited thereto. The wireless communication unit 1184 may also identify and authenticate the aerosol generating device 1100 within a communication network by using subscriber information (e.g., International Mobile Subscriber Identifier (IMSI)).

The controller 1110 may control general operations of the aerosol generating device 1100. In an embodiment, the controller 1110 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1110 may control the temperature of the heater 1150 by controlling supply of power of the battery 1140 to the heater 1150. For example, the controller 1110 may control power supply by controlling switching of a switching element between the battery 1140 and the heater 1150. In another example, a direct heating circuit may also control power supply to the heater 1150 according to a control command of the controller 1110.

The controller 1110 may analyze a result sensed by the sensing unit 1120 and control subsequent processes to be performed. For example, the controller 1110 may control power supplied to the heater 1150 to start or end an operation of the heater 1150 on the basis of a result sensed by the sensing unit 1120. As another example, the controller 1110 may control, based on a result sensed by the sensing unit 1120, an amount of power supplied to the heater 1150 and the time the power is supplied, such that the heater 1150 may be heated to a certain temperature or maintained at an appropriate temperature.

The controller 1110 may control the output unit 1130 on the basis of a result sensed by the sensing unit 1120. For example, when the number of puffs counted through the puff sensor 1126 reaches a preset number, the controller 1110 may notify the user that the aerosol generating device 1100 will soon be terminated through at least one of the display unit 1132, the haptic unit 1134, and the sound output unit 1136.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a cylindrical accommodation portion having an accommodation space configured to accommodate at least a portion of a cigarette in an inner space;
a coil arranged outside the accommodation portion to generate an induced magnetic field;
a battery configured to supply power to the coil;
a sensor connector including a metal material, and arranged in the accommodation portion to contact the cigarette;
a temperature sensor contacting the sensor connector; and
two or more cigarette support elements configured to support an outer surface of the cigarette, and spaced apart from each other on an inner wall of the accommodation portion to form an air flow passage between the cigarette and the accommodation portion.

2. The aerosol generating device of claim 1, wherein the sensor connector is integrally formed with the accommodation portion, and one end of the temperature sensor is welded to the sensor connector.

3. The aerosol generating device of claim 1, wherein the accommodation portion includes a connection hole formed at a location corresponding to the sensor connector, and one end of the temperature sensor is in contact with the sensor connector through the connection hole.

4. The aerosol generating device of claim 1, wherein the sensor connector is located at at least one of an upper end portion and a lower end portion of the cigarette support element in a longitudinal direction, and one end of the temperature sensor is in contact with the sensor connector, inside the accommodation portion, and another end of the temperature sensor is located outside the accommodation portion.

5. The aerosol generating device of claim 1, wherein the accommodation portion includes an accommodation groove, and the sensor connector includes a base configured to couple to the accommodation groove, and a protrusion protruding from the base to connect with the cigarette support element.

6. The aerosol generating device of claim 1, wherein the coil is wound around a central axis extending in a direction crossing a longitudinal direction of the accommodation portion, and is arranged to surround a portion of an outer circumferential surface of the accommodation portion.

7. The aerosol generating device of claim 6, wherein the accommodation portion further includes a coil support portion in one region of the outer circumferential surface, and the coil is wound around the coil support portion.

8. The aerosol generating device of claim 6, wherein the coil is wound around each of a plurality of central axes spaced apart from each other, and the sensor connector is arranged spaced apart from the coil, between the plurality of central axes.

9. The aerosol generating device of claim 1, further comprising a susceptor configured to generate heat due to a magnetic field generated by the coil, and arranged to surround at least a portion of the cigarette to heat the cigarette, wherein the susceptor and the sensor connector are spaced part from each other.

10. The aerosol generating device of claim 9, wherein the susceptor is insert molded into the accommodation portion or arranged adjacent to an inner circumferential surface of the accommodation portion.

11. An aerosol generating system comprising:
a cigarette including an aerosol generating material and a tobacco material;
a cylindrical accommodation portion having an accommodation space configured to accommodate at least a portion of the cigarette in an inner space;
a coil arranged along an outer circumferential surface of the accommodation portion to generate an induced magnetic field;
a susceptor configured to generate heat due to a magnetic field generated by the coil, to heat the cigarette;
a battery configured to supply power to the coil;
a sensor connector including a metal material, and arranged in the accommodation portion to contact the cigarette;
a temperature sensor contacting the sensor connector; and
two or more cigarette support elements supporting an outer surface of the cigarette, and spaced apart from each other on an inner wall of the accommodation portion to form an air flow passage between the cigarette and the accommodation portion.

12. The aerosol generating system of claim 11, wherein the susceptor is included inside the cigarette, insert molded into the accommodation portion, or arranged adjacent to an inner circumferential surface of the accommodation portion.

13. The aerosol generating system of claim 12, wherein the cigarette comprises a tobacco rod and a filter rod, and the susceptor is included inside a wrapper surrounding at least a portion of the tobacco rod.

14. The aerosol generating system of claim 13, wherein the tobacco rod of the cigarette comprises: a first segment including the aerosol generating material; and a second segment including the tobacco material, when the cigarette is inserted into the accommodation portion, the sensor connector includes: a first sensor connector arranged at a location corresponding to the first segment; and a second sensor connector arranged at a location corresponding to the second segment, and the temperature sensor comprises: a first temperature sensor which contacts the first sensor connector to measure a temperature of the first segment; and a second temperature sensor which contacts the second sensor connector to measure a temperature of the second segment.

15. A method of manufacturing the aerosol generating device of claim 1, the method comprising integrally forming the sensor connector and the accommodation portion by using an insert molding method.
